(19) United States
(12) Patent Application Publication
(10) Pub. No.: US 2014/0300121 A1
(43) Pub. Date: Oct. 9, 2014

(54) DEVICE FOR GRIPPING CRYOGENIC VIALS

(71) Applicant: Biocision, LLC, Mill Valley (CA)

(72) Inventor: Brian Schryver, Redwood City, CA (US)

(73) Assignee: Biocusion, LLC, Mill Valley, CA (US)

(21) Appl. No.: 14/357,175

(22) PCT Filed: Nov. 8, 2012
(86) PCT No.: PCT/US2012/064156

§ 371 Date: May 8, 2014

Related U.S. Application Data
(60) Provisional application No. 61/557,282, filed on Nov. 8, 2011.

(51) Int. Cl. B25B 9/02

(52) U.S. Cl. CPC B25B 9/02
USPC 294/99.2

(57) ABSTRACT

Device for gripping cryogenic vials.

### BACKGROUND OF THE INVENTION

Liquid nitrogen is a refrigerant that is commonly used for low temperature storage of samples, because it can maintain a temperature of −196° C. At such a low temperature, there is insufficient thermal energy and liquid water present for chemical reactions and biological processes to take place. Therefore, maintaining samples in liquid nitrogen can preserve them for long periods of time.

Because of the extremely low temperature of liquid nitrogen, handling of storage vessels (e.g., cryogenic vials) submerged in liquid nitrogen can be difficult. Such handling may be necessary when the storage vessels need to be retrieved from low temperature storage devices, or when the storage vessels need to be moved between low temperature storage devices. Direct contact of liquid nitrogen with skin can cause cold burns, and many materials that are generally used for protection of skin (e.g., vinyl, latex, or nitrile gloves) become brittle upon contact with liquid nitrogen.

Storage vessels such as cryogenic vials that are submerged in liquid nitrogen are therefore preferably handled with forceps. However, the commonly available forceps are not designed to grip the generally smooth and rounded surfaces of cryogenic vials. Rather than trying to grip the vials along the vial bodies it is thus often easier to try to grip the rims of the caps of the vials with the forceps. However, this too becomes impossible when the caps do not comprise rims, such as may be the case when plugs are used in the caps (e.g., for labeling of the cryogenic vials). The problem is compounded by the fact that cryogenic vials that have been submerged in liquid nitrogen must be handled very rapidly to prevent significant warming of their contents. Contents of cryogenic vials exposed to room temperature can rise in temperature from −80° C. to over −50° C. in less than a minute.

To facilitate handling of cryogenic vials that have been stored in liquid nitrogen, a device is needed for securely and rapidly gripping cryogenic vials. The present invention provides such a device.

### BRIEF DESCRIPTION OF THE DRAWINGS

FIG. 1 is a schematic view of a device of the invention for gripping cryogenic vials.

FIG. 2 is a line drawing of an embodiment of the device of the invention with dimensions shown.

FIG. 3 is a line drawing of an embodiment of the invention with dimensions shown.

### DETAILED DESCRIPTION OF THE INVENTION

In one aspect, the invention provided herein is a device for gripping cryogenic vials, wherein the device comprises two grasping arms, wherein the grasping arms are connected to each other at one end by a joint, wherein each gasping arm comprises at the end opposite of the joint a tip, and wherein each tip comprises a rounded spade.

A cryogenic vial is a vessel in which a sample can be placed for storage in liquid nitrogen. The cryogenic vial generally comprises a tube in which the sample may be placed, and a cap with which the tube can be sealed. Cryogenic vials are made of materials that can sustain the low temperature of a liquid nitrogen environment (e.g., polypropylene). The volume of a cryogenic vial is typically 1 mL, 1.2 mL, 2 mL, 3 mL, 4 mL, 5 mL, or 10 mL. Suitable cryogenic vials are available, for example, from Sigma-Aldrich, Inc. (St. Louis, Mo.; product numbers CLS320289, CLS430658, CLS430659, CLS430661, CLS430662, CLS430663, CLS430487, CLS430488, CLS43049, CLS430490, CLS430491, CLS430492, CLS430656, V9255, V9380, V8130, and many more).

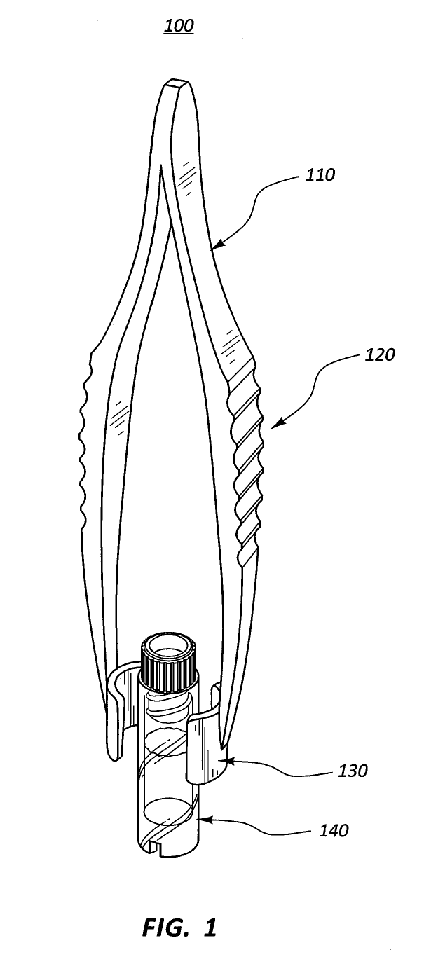

The device of the invention and its various features may be appreciated with reference to the illustrative embodiments shown in FIGS. 1, 2, and 3.

Referring to FIG. 1, the device 100 comprises two grasping arms 120. The grasping arms are connected to each other at one end by a joint 110. The joint may have spring tension with which the grasping arms are held apart until pressure is applied to the outside surface of one or both of the grasping arms. Each grasping arm at the end opposite of the joint has a tip. Each tip comprises a rounded spade 130. The curvature of the rounded spade conforms to the curvature of the cryogenic vial 140 to be handled.

The inside surface of the rounded spade may be smooth, cross-hatched, or serrated. The outside surface of the two grasping arms may be smooth or cross-hatched (e.g., to facilitate gripping) or mostly smooth with a limited cross-hatched gripping area.

The spring tension of the joint is large enough to separate the grasping arms far enough so that the rounded spades at the tips fit around the cryogenic vial to be handled. The spring tension of the joint may cause the gripping areas on the grasping arms to be separated by between about 0.5 inch to 3 inches; 0.5 inch to 1.5 inches; 1 inch to about 2 inches, and 1.5 inches to 3 inches, for example and without limitation.

The grasping arms may be wholly or partially made out of metal (e.g., stainless steel) or plastic (e.g., polyethylene, polypropylene, polycarbonate/acrylonitrile butadiene styrene (PC/ABS) blends, fluoroethylene-propylene (FEP), tetrafluoroethylene and perfluoralkyl vinyl ether copolymer (PFA), polytetrafluoroethylene (PCTFE), or a nylon-based resin such as Zytel 80G33 produced by DuPont). The grasping arms may comprise a coating throughout or only in a limited gripping area (e.g, for insulation).

The lengths of the grasping arms may be between 3 inches and 8 inches, and typically are between 4 inches and 6 inches. The width of each gripping arm may be between 0.1 inch and 1 inch. The width of each gripping arm may be constant along the length of the gripping arm, or it may vary.

In some embodiments, the tips and rounded spades are made from a material that can withstand the low temperature of a liquid nitrogen environment (e.g., stainless steel, polypropylene, polyethylene, Zytel 80G33). In one embodiment, the grasping arms, joint, tips, and rounded spades are made of the same material.

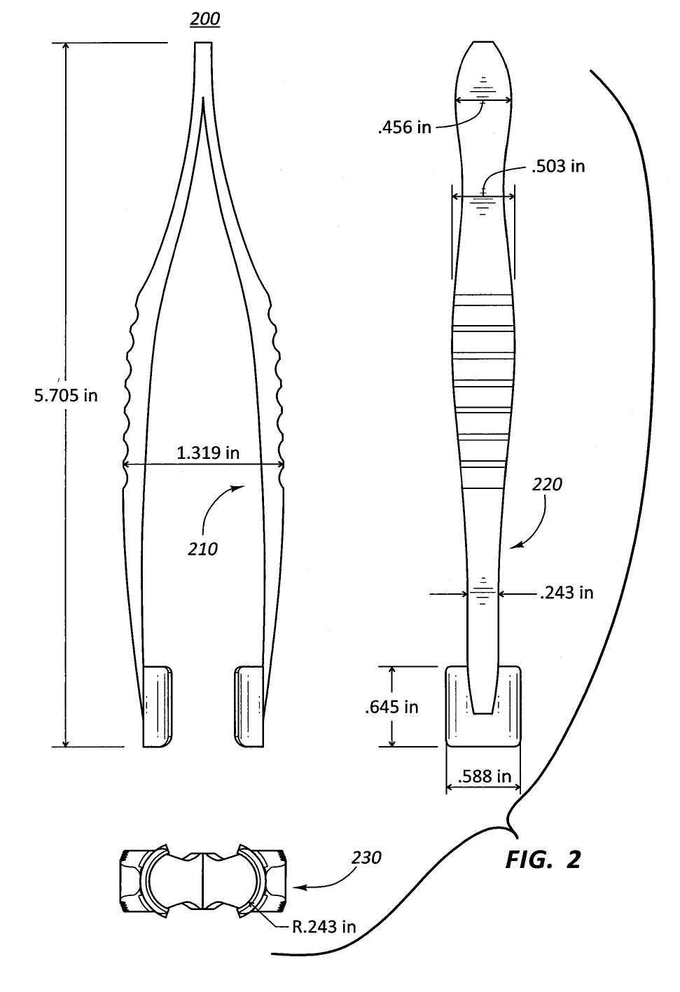

One embodiment of the device is shown in FIG. 2. In this embodiment, the length of each grasping arm is 5.705 inches, the spring tension of the join causes the gripping areas to be separated by 1.319 inches, the width of each gripping arm varies along the length of the gripping arm from 0.243 inch near the tip over 0.503 inch at the gripping area to 0.456 inch at the joint, the width of the rounded spade at the tip is 0.568 inch, the height of the rounded spade at the tip is 0.645 inch, and the curvature of the rounded spade has a radius of 0.243 inch.

The device provided herein is used to grip a cryogenic vial. For such gripping, the grasping arms are either manually separated or the spring tension in the joint is allowed to separate the grasping arms so that the rounded spades at the tips of the device can be lowered from above over (or laterally around) the cryogenic vial standing vertically and the rounded spades can be fit around the outside of the cryogenic vial. Pressure is then applied to the outside of one or both grasping arms so that the rounded spades at the tips are pressed against the outside surface of the cryogenic vial. While maintaining pressure on the outside of the grasping arms, the user can then lift and move the cryogenic vial to another location.

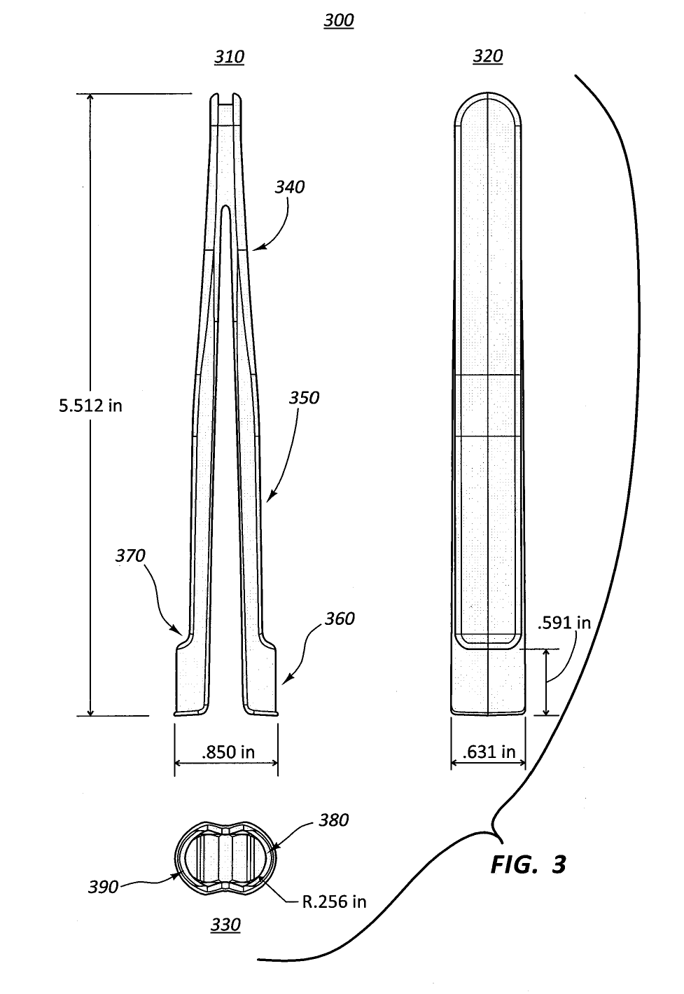

FIG. 3 shows another embodiment of the invention, having the dimensions shown. The device in front view 310 has an overall length of approximately 5.5 inches and a maximum width of approximately 0.85 inches. An upper region 340 has a thin cross-section to provide an area of flexure and spring tension to resist compressive closing force. The mid-region 350 comprises a flat area to provide multiple grip position options. The lower region 360 comprises two opposing semi-cylindrical extensions for gripping the top of the cryogenic vials. A shoulder feature 370 limits the depth of cryogenic vial grip and provides resistance to upward slippage during insertion of the vial into rack storage systems. The device shown in side-view 320 has a maximum width of approximately 0.63 inches and a cryogenic vial grip depth of approximately 5.9 inches. The device shown in end-view 330 has a cryogenic vial grip inside radius 390 of approximately 0.25 inches. The cryogenic vial insertion depth-stop shoulder 380 is visible in the end-view.

The device described herein in FIG. 3 is to be used by gripping the device with the thumb and forefinger in the region 350 in a pinching position. The opposing semi-cylindrical regions 360, 390 of the device are used to surround the upper end of a cryogenic vial and through compression of the grip regions 350, allow the user to apply lateral pressure to the sides of the vial, thereby providing sufficient contact friction to remove, manipulate and insert the vials to and from storage containers. The grip regions 350 extend to the cryogenic vial contact regions 360 thereby allowing repositioning of the hand-grip position close to the extensions to gain a mechanical advantage when increased grip pressure is required. The semi-cylindrical shape 390 of the gripping extensions act to prevent lateral slippage of the cryogenic vial and to maintain the vial in an axial orientation with the device shown. A shoulder region 370, 380 at the upper end of the grip extensions 360 limits the depth to which the cryogenic vial may be contacted, thereby preventing upward slippage of the vial when the vial is forcibly inserted into rack receptacles.

The devices of the invention, which may be referred to as cryovial grippers, are an ideal tool to protect fingers when extracting frozen tubes from cryoboxes and other cell (or other material) freezing containers. The unique design of the device allow the user to grip cryovials by the cap, lift the tube, and move it to a new position. The device protects fingers from exposure to frost and cold surfaces when maneuvering cryovials and protects the crovials and their contents from the heat transfer that would result from contacting them directly with the fingers of one's hand. The devices can be used with internal or external-threaded tubes.

The invention also provides methods for moving cryovials from one location to another, said method comprising gripping a cryovial with a device of the invention by contacting two opposing side surfaces of the cryovial with the grasping arms of the device, exerting pressure on the grasping arms sufficient to maintain the cryovial between the arms, moving the device with cryovial to a desired second location, and releasing the pressure on the arms such that the cryovial is released from the arms into the desired second location.

The invention, having been described in detail and with respect to its general aspects and particular embodiments, is set

1. A device for gripping a cryogenic vial, wherein the device comprises two grasping arms, wherein the grasping arms are connected to each other at one end by a joint, wherein each gasping arm comprises at the end opposite of the joint a tip, wherein each tip comprises a rounded spade, and wherein the rounded spade has a curvature that conforms to the curvature of the cryogenic vial.

2. The device of claim 1 wherein the joint has spring tension.

3. The device of claim 2 wherein the spring tension is sufficient to separate the grasping arms so that the rounded spades at the tips fit around the cryogenic vial.

4. The device of claim 1 wherein the curvature of the rounded spade conforms to the curvature of a cryogenic vial of a volume of 1 mL.

5. The device of claim 1 wherein the curvature of the rounded spade conforms to the curvature of a cryogenic vial of a volume of 1.2 mL.

6. The device of claim 1 wherein the curvature of the rounded spade conforms to the curvature of a cryogenic vial of a volume of 2 mL.

7. The device of claim 1 wherein the curvature of the rounded spade conforms to the curvature of a cryogenic vial of a volume of 3 mL.

8. The device of claim 1 wherein the curvature of the rounded spade conforms to the curvature of a cryogenic vial of a volume of 4 mL.

9. The device of claim 1 wherein the curvature of the rounded spade conforms to the curvature of a cryogenic vial of a volume of 5 mL.

10. The device of claim 1 wherein the curvature of the rounded spade has a radius of 0.243 inch.

11. The device of claim 1 wherein the inside surface of the rounded spade is smooth.

12. The device of claim 1 wherein the inside surface of the rounded spade is cross-hatched.

13. The device of claim 1 wherein the outside surface of the two grasping arms comprises a cross-hatched gripping area.

14. The device of claim 1 wherein the length of the grasping arms is between 4 inches and 6 inches.

15. The device of claim 1 wherein the grasping arms are made of stainless steel.

16. (canceled)

17. The device of claim 1 wherein the grasping arms comprise a material selected from the group consisting of polypropylene and polyethylene.

18. The device of claim 1 wherein the grasping arms comprise a coating in at least a limited gripping area for insulation.

19. The device of claim 1 wherein the tips and rounded spades are made from a material that can withstand the low temperature of a liquid nitrogen environment.

20. The device of claim 19 wherein the tips and rounded spades are made from stainless steel.

21. The device of claim 19 wherein the tips and rounded spades are made from polypropylene.
